(19) United States
(12) Patent Application Publication
(10) Pub. No.: US 2011/0163795 A1
(43) Pub. Date: Jul. 7, 2011

(54) SEMICONDUCTOR CIRCUIT AND COMPUTER SYSTEM

(75) Inventor: Shin ITO, Tokyo (JP)

(73) Assignee: Elpida Memory, Inc.

(21) Appl. No.: 12/981,057

(22) Filed: Dec. 29, 2010

(30) Foreign Application Priority Data
Jan. 6, 2010 (JP) 2010-001091

(51) Int. Cl. G05F 1/10

(52) U.S. Cl. 327/535

(57) ABSTRACT

A device includes, but is not limited to, a first transistor, a first current mirror circuit, a second transistor, and a first compensation circuit. The first transistor is controlled by a first control voltage. The first current mirror circuit is driven by the first transistor as a first current source. The second transistor is driven by the first current mirror circuit. The second transistor has a first output voltage that varies depending on the first control voltage. The first compensation circuit reduces variations of the first output voltage. The variations of the first output voltage are caused by variations in performance of the first and second transistors.

### BACKGROUND OF THE INVENTION

1. Field of the Invention

The present invention relates to a semiconductor circuit and a computer system, and more particular to a semiconductor circuit and a computer system which reduce the effect of variation on performance thereof due to variation in manufacturing processes or operation environments of a semiconductor device.

Priority is claimed on Japanese Patent Application No. 2010-001091, filed Jan. 6, 2010, the content of which is incorporated herein by reference.

2. Description of the Related Art

Japanese Unexamined Patent Application, First Publications, Nos. 2001-68976, 8-272467, 11-88072, and 4-315895 each disclose that semiconductor circuits using a semiconductor element, typically a metal oxide semiconductor field effect transistor such as a MOS transistor, are known to have performances which vary depending upon operation environments such as a power supply voltage or temperature, and upon manufacturing variations. Variations on performances of a semiconductor element may cause that operations of a semiconductor circuit including the semiconductor element is unstable and does not function normally. There is a technique to reduce effects of variations on performance of a semiconductor device and to stabilize operations of a semiconductor circuit that includes the semiconductor device.

### SUMMARY

In one embodiment, a device may include, but is not limited to, a first transistor, a first current mirror circuit, a second transistor, and a first compensation circuit. The first transistor is controlled by a first control voltage. The first current mirror circuit is driven by the first transistor as a first current source. The second transistor is driven by the first current mirror circuit. The second transistor has a first output voltage that varies depending on the first control voltage. The first compensation circuit reduces variations of the first output voltage. The variations of the first output voltage arc caused by variations in performance of the first and second transistors.

In another embodiment, a semiconductor circuit may include, but is not limited to, a first transistor, a first current mirror circuit, a second transistor, and a first compensation circuit. The first transistor has a first control terminal that receives a first control voltage. The first transistor is eclectically coupled between a first power line and a first node. The first current mirror circuit has a first input being electrically coupled to the first node. The first current mirror circuit has a first output which is electrically coupled to a second node. The second transistor has a first control terminal that is electrically coupled to the second node. The second transistor is electrically coupled between a second power line and a third node. The first compensation circuit is electrically coupled between the second node and the first power line. The first compensation circuit compensates a first variation in performance of the first transistor. The first compensation circuit compensates a second variation in performance of the second transistor.

In still another embodiment, a computer system may include, but is not limited to, a processor, and a storage unit storing information. The storage unit may include, but is not limited to, a peripheral circuit and a semiconductor circuit. The peripheral circuit controls read and write operations to the storage area. The semiconductor circuit may include, but is not limited to, a first transistor, a first current mirror circuit, a second transistor, and a first compensation circuit. The first transistor is controlled by a first control voltage. The first current mirror circuit is driven by the first transistor as a first current source. The second transistor is driven by the first current mirror circuit. The second transistor has a first output voltage that varies depending on the first control voltage. The first compensation circuit reduces variations of the first output voltage. The variations of the first output voltage are caused by variations in performance of the first and second transistors.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a circuit diagram illustrating a semiconductor circuit in accordance with a first embodiment of the present invention;

FIG. 2 is a circuit diagram illustrating a semiconductor circuit in accordance with a second embodiment of the present invention;

FIG. 3 is a block diagram illustrating a computer system in accordance with a third embodiment of the present invention; and

FIG. 4 is a block diagram illustrating a DRAM in accordance with an embodiment of the present invention.

### DETAILED DESCRIPTION OF THE PREFERRED EMBODIMENTS

Before describing the present invention, the related art will be explained, in order to facilitate the understanding of the present invention.

A step-down circuit includes an N channel metal oxide semiconductor field effect transistor, hereinafter referred to as an NMOS transistor, which is used as a source follower configuration. The step-down circuit with the source follower configuration supplies an output voltage Vref to a gate terminal of the NMOS transistor. The output voltage Vref will be hereinafter referred to as a reference voltage Vref. The output voltage Vref is of a reference voltage source VREF stabilized using a band gap reference (BGR) circuit or the like. The step-down circuit with the source follower configuration applies a higher power supply voltage than the reference voltage Vref to a drain terminal of the NMOS transistor. A stabilized step-down potential VDDI may be obtained from a source terminal.

On the other hand, a step-down circuit of a voltage follower configuration using an operational amplifier may suppress effects that may be caused due to variations on performances of a MOS transistor in the step-down circuit of the above-described source follower configuration. It is possible to obtain an output potential having a higher accuracy than that of the step-down circuit of the above-described source follower configuration. The operational amplifier has a circuit scale which is larger than that of the step-down circuit of the above-described source follower configuration. A phase compensation capacitor is necessary to prevent oscillation phenomenon. A chip layout area is necessary, which is larger than that of the step-down circuit of the above-described source follower configuration.

Thus, the step-down circuit including the NMOS transistor with the source follower configuration is effective in reducing the chip size.

However, the step-down circuit including the NMOS transistor with the source follower configuration has the step-down potential VDDI at which the potential is decreased by a gate-source voltage VGS from the reference voltage Vref. Even when the reference voltage source VREF is stable, a threshold voltage Vth of the NMOS transistor for the source follower varies by variations on manufacturing processes or temperature dependency. When the threshold voltage Vth varies, VGS consequently varies. The step-down potential VDDI supplied from the source terminal of the NMOS transistor will vary due to the variation on the manufacturing processes or the temperature dependency.

Embodiments of the invention will be now described herein with reference to illustrative embodiments. Those skilled in the art will recognize that many alternative embodiments can be accomplished using the teaching of the embodiments of the present invention and that the invention is not limited to the embodiments illustrated for explanatory purpose.

In one embodiment, a device may include, but is not limited to, a first transistor, a first current mirror circuit, a second transistor, and a first compensation circuit. The first transistor is controlled by a first control voltage. The first current mirror circuit is driven by the first transistor as a first current source. The second transistor is driven by the first current mirror circuit. The second transistor has a first output voltage that varies depending on the first control voltage. The first compensation circuit reduces variations of the first output voltage. The variations of the first output voltage are caused by variations in performance of the first and second transistors.

In some cases, the first transistor is electrically coupled to a first node as an input terminal that controls a first output current from the first current mirror circuit. The first transistor has a first control terminal that receives the first control voltage. The second transistor has a second control terminal that is electrically coupled to a second node as an output terminal of the first current mirror circuit. The first compensation circuit is electrically coupled to the second node.

In some cases, the first current mirror circuit may include, but is not limited to, a third transistor, and a fourth transistor. The third transistor is electrically coupled between a first power line and the first node. The third transistor has a third control terminal that is electrically coupled to the first node. The fourth transistor is electrically coupled between the first power line and the second node. The fourth transistor has a fourth control terminal that is electrically coupled to the first node. The first transistor is electrically coupled between the first node and a second power line which is different in potential from the first power line. The first compensation circuit may include, but is not limited to, a fifth transistor and a sixth transistor. The fifth transistor is electrically coupled between the second node and a third node. The fifth transistor has a fifth control terminal that is electrically coupled to the second node. The sixth transistor is electrically coupled between the second power line and the third node. The sixth transistor has a sixth control terminal that is electrically coupled to the third node.

In some cases, the third and fourth transistors are first conductivity type transistors. The first, second, fifth and sixth transistors are second conductivity type transistors.

In some cases, the fifth transistor is connected in source-follower configuration between the second node and the third node.

In some cases, the device may include, but is not limited to, a second current mirror circuit driven by the second transistor as a second current source. The second current mirror circuit has an input electrically coupled to a fourth node. The first compensation circuit reduces variations of a second output current from the second current mirror circuit.

In some cases, the device may include, but is not limited to, a first resistance electrically coupled between the second transistor and the second power line. The second transistor is eclectically coupled between the fourth node and the first resistance.

In some cases, the second current mirror circuit may include, but is not limited to, a seventh transistor and an eighth transistor. The seventh transistor is electrically coupled between the first power line and the fourth node. The seventh transistor has a seventh control terminal that is electrically coupled to the fourth node. The eighth transistor is electrically coupled between the first power line and an output of the second current mirror circuit. The eighth transistor has an eighth control terminal that is electrically coupled to the fourth node.

In another embodiment, a semiconductor circuit may include, but is not limited to, a first transistor, a first current mirror circuit, a second transistor, and a first compensation circuit. The first transistor has a first control terminal that receives a first control voltage. The first transistor is eclectically coupled between a first power line and a first node. The first current mirror circuit has a first input being electrically coupled to the first node. The first current mirror circuit has a first output which is electrically coupled to a second node. The second transistor has a first control terminal that is electrically coupled to the second node. The second transistor is electrically coupled between a second power line and a third node. The first compensation circuit is electrically coupled between the second node and the first power line. The first compensation circuit compensates a first variation in performance of the first transistor. The first compensation circuit compensates a second variation in performance of the second transistor.

In some cases, the first compensation circuit may include, but is not limited to, a third transistor and a fourth transistor. The third transistor compensates the first variation in performance of the first transistor. The fourth transistor compensates the second variation in performance of the second transistor.

In some cases, the third transistor is electrically coupled between the second node and a third node. The third transistor has a third control terminal that is electrically coupled to the second node. The fourth transistor is electrically coupled between the second power line and the third node. The fourth transistor has a fourth control terminal that is electrically coupled to the third node.

In some cases, the first current mirror circuit may include, but is not limited to, a fifth transistor, and a sixth transistor. The fifth transistor is electrically coupled between the second power line and the first node. The fifth transistor has a third control terminal that is electrically coupled to the first node. The sixth transistor is electrically coupled between the second power line and the second node. The sixth transistor has a sixth control terminal that is electrically coupled to the first node.

In still another embodiment, a computer system may include, but is not limited to, a processor, and a storage unit storing information. The storage unit may include, but is not limited to, a peripheral circuit and a semiconductor circuit. The peripheral circuit controls read and write operations to the storage area. The semiconductor circuit may include, but is not limited to, a first transistor, a first current mirror circuit, a second transistor, and a first compensation circuit. The first transistor is controlled by a first control voltage. The first current mirror circuit is driven by the first transistor as a first current source. The second transistor is driven by the first current mirror circuit. The second transistor has a first output voltage that varies depending on the first control voltage. The first compensation circuit reduces variations of the first output voltage. The variations of the first output voltage are caused by variations in performance of the first and second transistors.

In some cases, the first transistor is electrically coupled to a first node as an input terminal that controls a first output current from the first current mirror circuit. The first transistor has a first control terminal that receives the first control voltage. The second transistor has a second control terminal that is electrically coupled to a second node as an output terminal of the first current mirror circuit. The first compensation circuit is electrically coupled to the second node.

In some cases, the first current mirror circuit may include, but is not limited to, a third transistor, and a fourth transistor. The third transistor is electrically coupled between a first power line and the first node. The third transistor has a third control terminal that is electrically coupled to the first node. The fourth transistor is electrically coupled between the first power line and the second node. The fourth transistor has a fourth control terminal that is electrically coupled to the first node. The first transistor is electrically coupled between the first node and a second power line which is different in potential from the first power line. The first compensation circuit may include, but is not limited to, a fifth transistor and a sixth transistor. The fifth transistor is electrically coupled between the second node and a third node. The fifth transistor has a fifth control terminal that is electrically coupled to the second node. The sixth transistor is electrically coupled between the second power line and the third node. The sixth transistor has a sixth control terminal that is electrically coupled to the third node.

In some cases, the third and fourth transistors are first conductivity type transistors. The first, second, fifth and sixth transistors are second conductivity type transistors.

In some cases, the fifth transistor is connected in source-follower configuration between the second node and the third node.

In some cases, the device may include, but is not limited to, a second current mirror circuit driven by the second transistor as a second current source. The second current mirror circuit has an input electrically coupled to a fourth node. The first compensation circuit reduces variations of a second output current from the second current mirror circuit.

In some cases, the device may include, but is not limited to, a first resistance electrically coupled between the second transistor and the second power line. The second transistor is eclectically coupled between the fourth node and the first resistance.

In some cases, the second current mirror circuit may include, but is not limited to, a seventh transistor and an eighth transistor. The seventh transistor is electrically coupled between the first power line and the fourth node. The seventh transistor has a seventh control terminal that is electrically coupled to the fourth node. The eighth transistor is electrically coupled between the first power line and an output of the second current mirror circuit. The eighth transistor has an eighth control terminal that is electrically coupled to the fourth node.

### First Embodiment

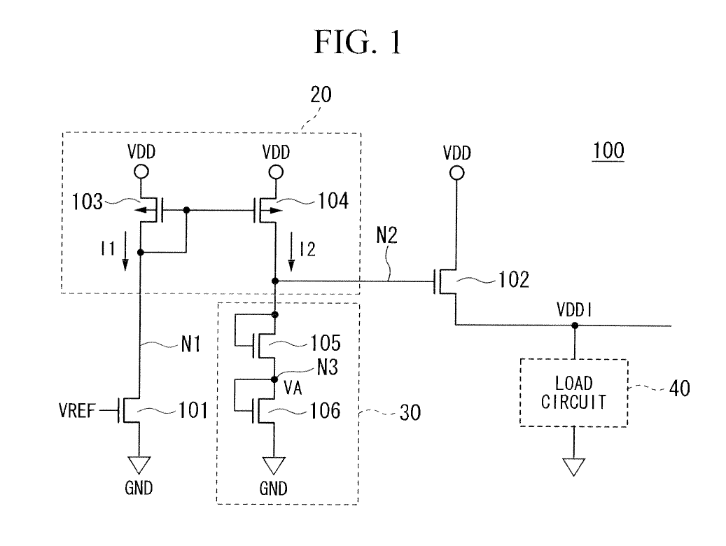

A step-down circuit as a semiconductor circuit according to the first embodiment of the present invention will be described with reference to the drawings. FIG. 1 is a block diagram showing a step-down circuit according to this embodiment. A step-down circuit 100 includes NMOS transistors 101 and 102, a current mirror circuit 20, and a compensation circuit 30.

The NMOS transistor 101 performs as a current source from which a current flows in response to a voltage Vref (hereinafter, referred to as a reference voltage Vref) supplied from a reference voltage source VREF. The NMOS transistor 101 has a source terminal connected to a ground potential GND, a gate terminal connected to the reference voltage source VREF, and a drain terminal connected to a node N1.

The NMOS transistor 102 is an output transistor of the step-down circuit 100. The NMOS transistor 102 supplies a step-down potential VDDI to a load circuit 40. The NMOS transistor 102 has a drain terminal connected to a power supply VDD and a gate terminal connected to a node N2. Also, the NMOS transistor 102 has a source follower configuration. The NMOS transistor 102 outputs the step-down potential VDDI from a source terminal.

The current mirror circuit 20 has an input terminal, an output terminal, and P channel metal oxide semiconductor field effect transistors (hereinafter referred to as PMOS transistors) 103 and 104. The current mirror circuit 20 supplies a current to the output terminal in response to a current flowing through the input terminal. In the current mirror circuit 20, the input terminal is connected to the node N1 and the output terminal is connected to the node N2.

In the current mirror circuit 20, the PMOS transistor 103 has a source terminal connected to the power supply VDD, and a gate terminal and a drain terminal that are connected to the node N1. The PMOS transistor 104 has a source terminal connected to the power supply VDD, a gate terminal connected to the node N1, and a drain terminal connected to the node N2.

A compensation circuit 30 has one terminal connected to the node N2 and the other terminal connected to a GND potential. Also, the compensation circuit 30 compensates for a step-down potential VDDI and reduces influence on the step-down potential VDDI by the variations on performances of the NMOS transistors 101 and 102. Here, the variations on performances of the NMOS transistors 101 and 102 are the variations on device performances caused by variations on manufacturing processes, temperature dependency, or the like.

The compensation circuit 30 includes NMOS transistors 105 and 106. The NMOS transistor 105 has a drain terminal and a gate terminal that are connected to the node N2 as a diode configuration, and a source terminal connected to a node N3. The NMOS transistor 106 has a drain terminal and a gate terminal that are connected to the node N3 as a diode configuration, and a source terminal grounded to GNU.

Even when semiconductor circuits are formed on the same substrate, variations on performances of the semiconductor devices may be caused by the layout of semiconductor elements constituting a semiconductor device. These variations on performances may be caused by variations on manufacturing processes or temperature differences within a semiconductor chip. In a large scale integrated circuit (LSI), the effect of the variations on performances increases. Thus, performances have a tendency to be irregular as a distance between semiconductor devices increases. In the chip layout, it is preferable to arrange a set of the PMOS transistors 103 and 104, a set of the NMOS transistors 101 and 106, and a set of the NMOS transistors 102 and 105 in proximity, provided that the effect of the variations on performances by the manufacturing variation or the temperature difference is acceptable.

Operation of this embodiment will be described.

When the reference voltage Vref from the reference voltage source VREF generated in a BGR circuit or the like is supplied to the gate terminal of the NMOS transistor 101, the NMOS transistor 101 supplies a current I1 to the node N1 in response to the reference voltage Vref. The current mirror circuit 20 receiving the current I1 supplies a current 12 to the node N2 by the PMOS transistors 103 and 104. The current I2 supplies from the current mirror circuit 20 flows to the NMOS transistors 105 and 106 of the compensation circuit 30 through the node N2. If element constants of the NMOS transistors 101 and 106 are identical and element constants of the PMOS transistors 103 and 104 are identical, the current I1 and the current I2 are identical (I1=I2) under the condition that the MOS transistors operate in a saturation region. Also, a potential VA of the node N3 is the same as the reference voltage Vref (VA=Vref).

The step-down potential VDD1, which is an output of the NMOS transistor 102 having the source follower configuration, becomes a potential decreased by a gate-source voltage VGS2 of the NMOS transistor 102 from a potential increased by a gate-source voltage VGS5 of the NMOS transistor 105 from the potential VA. That is, the step-down potential VDDI is expressed by Equation (1).

VDDI=VA+VGS5−VGS2 (1)

In Equation (1), threshold voltages Vth as thresholds of the NMOS transistors 102 and 105 are substantially the same values. Thus, a relationship of Equation (2) is established.

VGS5≈VGS2 (2)

The step-down potential VDDI, which is substantially the same potential as the reference voltage Vref, is output (VDDI≈Vref). The fluctuation of device performances due to variations on manufacturing processes or temperature dependency is shown as the fluctuation of Vth of the PMOS and NMOS transistors. If Vth of the MOS transistor is fluctuated by the manufacturing variation or the temperature dependency, Vth of the set of the PMOS transistors 103 and 104 and Vth of the set of the NMOS transistors 101 and 106 fluctuate to have the same fluctuation tendency for each set. The variations on performances can be mutually compensated for, and the potential VA of the node N3 can obtain a potential at which the effect of variations on performances is reduced. Also, Vth of the NMOS transistors 102 and 105 fluctuates to have the same fluctuation tendency. Since VGS fluctuates in response to the fluctuation of Vth, VGS2 and VGS5 fluctuate to have the same fluctuation tendency. Consequently, the NMOS transistors 102 and 105 can he mutually compensated for, and the step-down potential VDDI can obtain a potential at which the effect of variations on performances is reduced. That is, the compensation circuit 30 can reduce the fluctuation of the step-down potential VDDI caused by the variations on performances.

As described above, the step-down circuit 100 has the compensation circuit 30 including the NMOS transistors 105 and 106. The NMOS transistor 106 performs an operation of mutually compensating for the variations on performances of the NMOS transistor 101, which receives the reference voltage Vref through the gate terminal and serves as a current source of the current mirror circuit 20. The NMOS transistor 105 performs an operation of mutually compensating for the variations on performances of the NMOS transistor 102 of the source follower configuration, which generates the step-down potential VDDI. That is, the compensation circuit 30 reduces the fluctuation of the step-down potential VDDI generated by the variations on performances of the NMOS transistors 101 and 102. The step-down circuit 100 can reduce the effect of variations on performances due to the manufacturing variation or the temperature dependency, and can obtain the stable step-down potential VDDI.

The step-down circuit 100 can obtain a highly accurate, stable step-down potential by the action of the compensation circuit 30, despite the fact that its output circuit has the source follower configuration. Also, the step-down circuit 100 can reduce a circuit scale as compared with a step-down circuit using an operational amplifier, and a phase compensation capacitor, which increases a layout area, becomes unnecessary. Thus, the step-down circuit 100 can reduce a chip layout area as compared with the step-down circuit using the operational amplifier.

### Second Embodiment

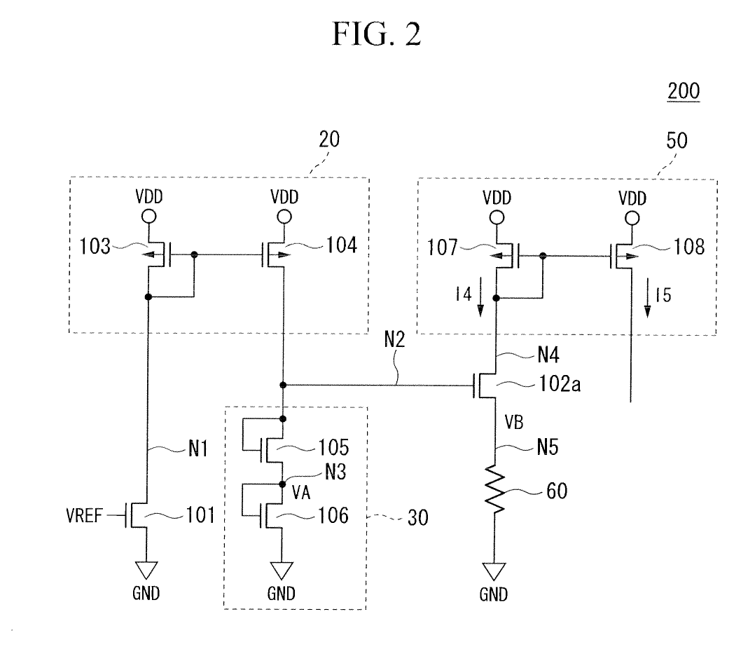

A constant current circuit, which is a semiconductor circuit, according to the second embodiment of the present invention will now be described with reference to the drawings. FIG. 2 is a block diagram showing the configuration of the constant current circuit in this embodiment. A constant current circuit 200 includes NMOS transistors 101 and 102a, current mirror circuits 20 and 50, a compensation circuit 30, and a resistance element 60.

In this figure, the same reference numerals are assigned to the same elements as those of FIG. 1.

The NMOS transistor 102a has a drain terminal connected to a node N4, a gate terminal connected to a node N2, and a source terminal connected to a node N5. Also, the NMOS transistor 102a has a source follower configuration in which the source terminal outputs a step-down potential VB.

The current mirror circuit 50 includes an input terminal, an output terminal, and PMOS transistors 107 and 108. The current mirror circuit 50 supplies a current, which is N times a current flowing through the input terminal, to the output terminal (N is a constant predetermined by an element constant). In the current mirror circuit 50, the input terminal is connected to the node N4, and the output terminal is a constant current power supply.

In the current mirror circuit 50, the PMOS transistor 107 has a source terminal connected to a power supply VDD, and a gate terminal and a drain terminal that are connected to the node N4. The PMOS transistor 108 has a source terminal connected to the power supply VDD and a gate terminal connected to the node N4.

The resistance element 60 is a current source of the current mirror circuit 50, and is connected between the node N5 and GND.

In the chip layout, it is preferable to arrange each of a set of the NMOS transistors 102a and 105 and a set of the PMOS transistors 107 and 108 in proximity in a range where the effect of variations on performances by variations on manufacturing processes or a temperature difference is allowable.

Operation of the device of this embodiment will be described.

The potential VB of the node N5 is substantially the same potential as a reference voltage source VREF. The potential VB of the node N5 is expressed by Equation (3). This operation is referred to from the first embodiment.

VB=VA+VGS5−VGS2a (3)

In Equation (3), VGS5 is a gate-source voltage of the NMOS transistor 105. VGS2a is a gate-source voltage of the NMOS transistor 102a.

If Vth of the MOS transistor is fluctuated by the manufacturing variation or the temperature dependency, Vth of the NMOS transistors 102a and 105 fluctuates to have the same fluctuation tendency. Since VGS fluctuates in response to the fluctuation of Vth, VGS2a and VGS5 fluctuate to have the same fluctuation tendency. Consequently, the NMOS transistors 102a and 105 can be mutually compensated for, and the potential VB can obtain a potential at which the effect of variations on performances is reduced. That is, the compensation circuit 30 can reduce fluctuation caused by the variations on performances of the potential VB.

A current I4 flowing through the node N4, which is the input terminal of the current mirror circuit 50, is decided by the potential VB and a resistance value R1 of the resistance element 60, and is expressed by Equation (4).

I4=VB/R1 (4)

In Equation (4), the current mirror circuit 50 receiving the current I4 outputs a current value I5 controlled by the PMOS transistors 107 and 108 as a constant current source. If a ratio of element constants of the PMOS transistors 107 and 108 is 1:N, the current I5 has a current value, which is N times the current I4, under the condition that each MOS transistors operates in a saturation region, and is expressed by Equation (5).

I5=N*I4 (5)

In Equation (5), N is a ratio of the element constants of the PMOS transistors 107 and 108, and is expressed by Equation (6).

N=(Element Constant of PMOS transistor 108)/(Element Constant of PMOS transistor 107) (6)

Accordingly, the constant current circuit 200 can change the current I5 to be supplied to an arbitrary value by the resistance value R1 of the resistance element 60 and the ratio N of the element constants of the PMOS transistors 107 and 108.

Since Vth of the set of the PMOS transistors 107 and 108 fluctuates to have the same fluctuation tendency, the current mirror circuit 50 can reduce the variations of the output current I5 caused by variations on performances if the potential VB is a stable value. By the action of the compensation circuit 30, the potential VB can reduce fluctuation caused by the variations on performances. From these, the constant current circuit 200 can reduce variations on performances of the output current I5.

As described above, the above-described constant current circuit 200 has the compensation circuit 30 including the NMOS transistors 105 and 106. The NMOS transistor 106 performs operations of receiving the reference voltage Vref through the gate terminal and compensating for the variations on performances of the NMOS transistor 101 serving as a current source of the current mirror circuit 20. The NMOS transistor 105 performs an operation of compensating for the variations on performances of the NMOS transistor 102a of the source follower configuration, which generates the potential VB. The step-down potential VB can reduce the effect of variations on performances due to variations on manufacturing processes or temperature dependency, and can obtain a stable voltage. The constant current circuit 200 can reduce the effect of variations on performances due to the manufacturing variation or the temperature dependency and can obtain the stable output current I5.

Despite the fact that the reference current I4 is generated by the NMOS transistor 102a, which has the source follower configuration, the constant current circuit 200 can obtain a highly accurate, stable constant current output by the action of the compensation circuit 30. Also, a circuit scale can be reduced as compared with a constant current circuit using an operational amplifier. Thus, a phase compensation capacitor, which increases a layout area, is unnecessary. Thus, the constant current circuit 200 can reduce a chip layout area as compared with the constant current circuit using the operational amplifier.

### Third Embodiment

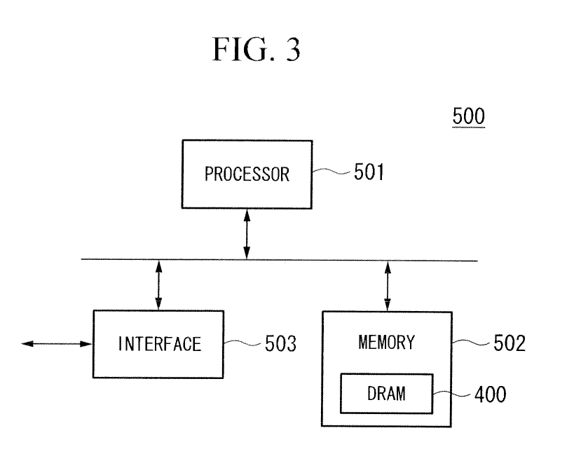

A computer system according to the third embodiment of the present invention will now be described with reference to the drawings. FIG. 3 is a block diagram showing the configuration of the computer system in this embodiment. A computer system 500 includes a processor unit 501, a storage unit 502, and an interface unit 503.

The processor unit 501 performs operations according to a program stored in the storage unit 502 on the basis of information supplied from the outside through the interface unit 503 or information stored in the storage unit 502. The processor unit 501 stores the operation result in the storage unit 502. Also, the processor unit 501 performs transmission to the outside through the interface unit 503.

Under control of the processor unit 501, the interface unit 503 transmits/receives information to and from outside.

The storage unit 502 includes a dynamic random access memory (DRAM) 400 and stores information under the control of the processor unit 501.

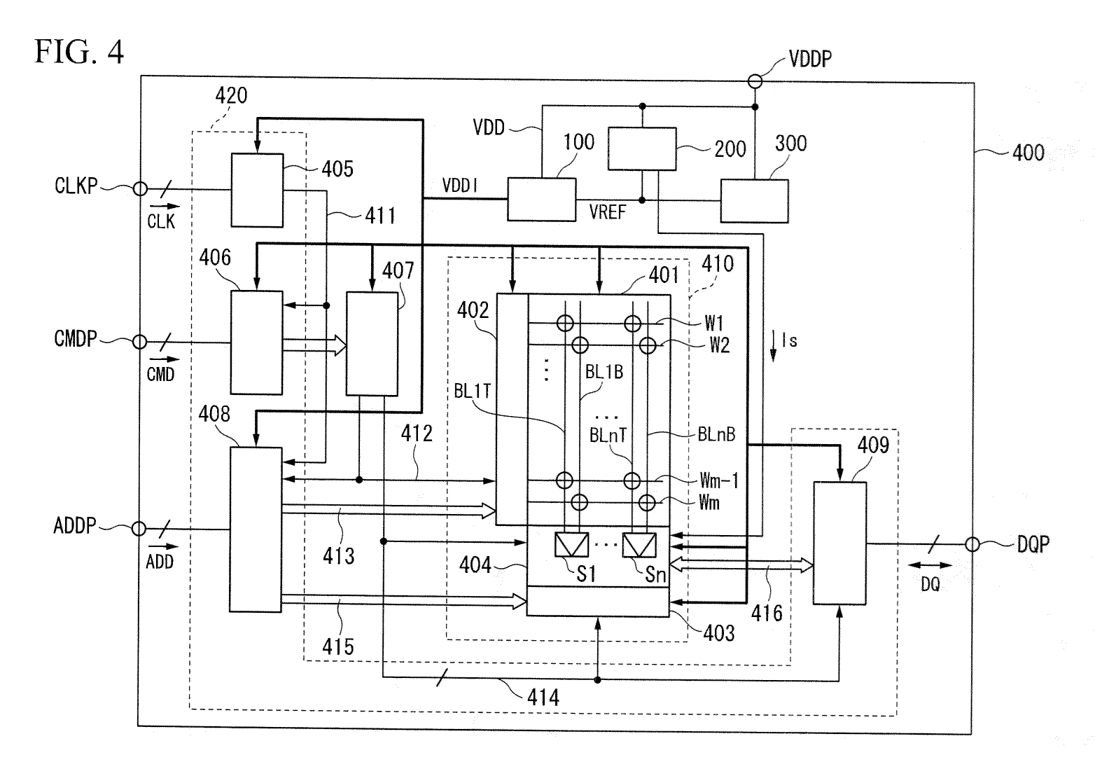

FIG. 4 is a block diagram showing the configuration of the DRAM 400.

In FIG. 4, the DRAM 400 includes a step-down circuit 100, a constant current circuit 200, a reference voltage generation circuit 300, a storage region 410, and a peripheral circuit unit 420.

The storage region 410 includes a memory cell array 401, an X decoder circuit 402, a Y decoder circuit 403, and a sense amplifier circuit 404. The storage region 410 stores information supplied from the processor unit 501.

The peripheral circuit unit 420 includes a control signal generation circuit 405, a command input latch circuit 406, a control logic circuit 407, an address input latch circuit 408, and a data input/output circuit 409. The peripheral circuit unit 420 controls write processing to the storage region 410 or read processing from the storage region.

The reference voltage generation circuit 300 generates the reference voltage Vref. The step-down circuit 100 supplies a step-down potential VDDI generated on the basis of a reference voltage Vref to the storage region 410 and the peripheral circuit unit 420 of the DRAM 400. The constant current circuit 200 supplies a constant current source Is generated on the basis of the reference voltage Vref to the sense amplifier circuit 404.

In FIG. 4, the memory cell array 401 includes a plurality of word lines W1 to Wm, a plurality of bit lines BL1T to BLnT and BL1B to BLnB, and a plurality of memory cells (m×n memory cells) arranged at intersections between the word lines and the bit lines. In the sense amplifier circuit 404, a plurality of sense amplifiers S1 to Sn are provided to amplify a difference voltage of each of bit line pairs (BL1T, BL1B) to (BLnT, BLnB) and read storage information of memory cells.

In FIG. 4, the step-down circuit 100, the constant current circuit 200, and the reference voltage circuit 300 are connected to an external power supply voltage terminal VDDP, so that a power supply voltage VDD applied to the external power supply voltage terminal VDDP is supplied.

Operation of the computer system of this embodiment will be described.

The processor unit 501 writes information supplied from the outside through the interface unit 503 to the storage unit 502, and stores the information in the storage unit 502. The processor unit 501 reads the information stored in the storage unit 502. The processor unit 501 performs operation processing. The processor unit 501 stores its result in the storage unit 502. The processing unit 501 reads the information stored in the storage unit 502 in response to the operation processing result. The processing unit 501 transmits the information to the outside through the interface unit 502.

The DRAM 400 of the storage unit 502 performs write processing to the storage region 410, or performs read processing from the storage region 410, by the peripheral circuit unit 420. On the basis of an external clock signal CLK, the control signal generation circuit 405 generates an internal clock signal 411 and respectively inputs a command signal CMD and an external address signal ADD to the command input latch circuit 406 and the address input latch circuit 408. The command signal CMD is decoded by the command input latch circuit 406. The command signal CMD is input to the control logic circuit 407.

In response to an input command, the control logic circuit 407 generates an X address system control signal 412, a Y address system control signal 414, or the like. The control logic circuit 407 performs an operation of writing or reading to or from a memory cell of the memory cell array 401. The address input latch circuit 408 supplies an X address signal 413 and a Y address signal 415 to the storage region 410. An operation of writing or reading data to or from a memory cell is performed in response to a data input/output signal DQ input/output via a data input/output terminal DQP, via the data input/output circuit 409, a data bus 416, and the sense amplifier circuit 404. At the time of this operation, the sense amplifier circuit 404 uses the constant current source Is.

Since the step-down circuit 100 and the constant current circuit 200 have the above-described compensation circuit 30, it is possible to reduce the effect of variations on performances due to variations on manufacturing processes or temperature dependency, and to obtain a stable voltage and current. Thus, a normal function is performed even when the temperature of the computer system 500 is raised by the operations of the processor unit 501 and the interface unit 503.

As described above, the computer system 500 has the processor unit 501, the storage unit 502, and the interface unit 503. In the DRAM 400 of the storage unit 502, the step-down circuit 100 and the constant current circuit 200 are provided. Since the step-down circuit 100 and the constant current circuit 200 have the above-described compensation circuit 30, it is possible to reduce the effect of variations on performances due to variations on manufacturing processes or temperature dependency and to obtain a stable voltage and current. The temperature fluctuates, the DRAM 400 can function normally and can be stably used. Since the storage unit 502 functions normally, the computer system 500 can function normally, and can be stably used, when the temperature is raised by its own operation.

According to the embodiment of the present invention, the NMOS transistor 101 having the gate terminal to which the reference voltage Vref is supplied is driven as a current source. The current mirror circuit 20 drives the NMOS transistor 102 (or 102a) varying an output voltage in response to the reference voltage Vref by receiving the current source from the NMOS transistor 101. The compensation circuit 30 is the step-down circuit 100 (or the constant current circuit 200) including a semiconductor circuit that reduces variations on the step-down potential VDDI (or VB), which is an output voltage of the NMOS transistor 102 (or 102a), caused by the variations on performances of the NMOS transistors 101 and 102 (or 102a).

The NMOS transistor 101 is connected to the node N1, which is an input terminal that controls a current value output by the current mirror circuit 20. The NMOS transistor 101 has the gate terminal that receives the reference voltage Vref, which controls the current of the current mirror circuit 20. The NMOS transistor 102 (or 102a) has the gate terminal connected to the node N2, which is an output terminal that supplies a current of the controlled current value. The compensation circuit 30 is connected to the node N2.

Since the compensation circuit 30 compensates for the variations on performances of the NMOS transistor 101 and the NMOS transistor 102 (or 102a), the semiconductor circuit can reduce the fluctuation of the step-down potential VDDI (or VB) caused by variations on performances due to the manufacturing variation or the temperature dependency.

The current mirror circuit 20 includes the PMOS transistor 103, which is connected between the power supply VDD and the node N1 and has the gate terminal connected to the node N1, and the PMOS transistor 104, which is connected between the power supply VDD and the node N2 and has the gate terminal connected to the node N1. The NMOS transistor 101 is connected to the node Ni and the power supply GND different from the power supply VDD. The compensation circuit 30 includes the NMOS transistor 105, which is connected between the node N2 and the node N3 and has the gate terminal connected to the node N2, and the NMOS transistor 106, which is connected between the node N3 and GND and has the gate terminal connected to the node N3.

The MOS transistor 106 performs an operation of receiving the reference voltage Vref through the gate terminal and mutually compensating for the variations on performances of the MOS transistor 101 serving as the current source of the current mirror circuit 20. The MOS transistor 105 performs an operation of mutually compensating for variations on performances of the MOS transistor 102 (or 102a), which generates the step-down potential VDDI (or VB). The step-down potential VDDI (or VB) can reduce the effect of variations on performances due to variations on manufacturing processes or temperature dependency, and can obtain a stable voltage. The semiconductor circuit can reduce the fluctuation of the step-down potential VDDI (or VB) caused by the variations on performances due to the manufacturing variation or the temperature dependency.

The NMOS transistor 102 (or 102a) is connected as a source follower circuit.

In the semiconductor circuit, it is possible to reduce a circuit scale as compared with a step-down circuit using an operational amplifier, and a phase compensation capacitor, which increases a layout area, becomes unnecessary. Thus, the step-down circuit 100 (or the constant current circuit 200) can reduce a chip layout area as compared with the step-down circuit using the operational amplifier.

In the computer system 500 including the storage unit 502 and the processor unit 501 that stores information in the storage unit 502, the DRAM 400 of the storage unit 502 includes the storage region 410, which stores information, and the peripheral circuit unit 420, which controls write processing to the storage region 410 or read processing from the storage region 410, and the NMOS transistor 101 to which the reference voltage Vref is supplied is driven as the current source. The current mirror circuit 20 drives the NMOS transistor 102 (or 102a) varying the step-down potential VDDI or VB, which is an output voltage, in response to the reference voltage Vref by receiving the current source from the NMOS transistor 101. The compensation circuit 30 reduces the fluctuation of the step-down potential VDDI or VB caused by the variations on performances of the NMOS transistor 101 and the NMOS transistor 102 or 102a. The DRAM 400 includes one or both of the step-down circuit 100 and the constant current circuit 200, which supply power to the peripheral circuit unit 420. The processor unit 501 stores information corresponding to processing in the storage unit 502 or refers to information stored in the storage unit 502.

The NMOS transistor 101 is connected to the node N1, which is an input terminal that controls a current value output by the current mirror circuit 20, and has the gate terminal that receives the reference voltage Vref, which controls the current of the current mirror circuit 20. The NMOS transistor 102 (or 102a) has the gate terminal connected to the node N2, which is an output terminal of the current mirror circuit 20. The compensation circuit 30 is connected to the node N2.

Since the step-down circuit 100 and the constant current circuit 200 include the compensation circuit 30, it is possible to reduce the effect of variations on performances due to the manufacturing variation or the temperature dependency, and to respectively supply a stable voltage and current. The step-down potential VDDI and the constant current Is are respectively supplied from the step-down circuit 100 and the constant current circuit 200. When the temperature fluctuates, the DRAM 400 can function normally and can be stably used. Consequently, since the storage unit 502 functions normally, the computer system 500 can function normally, and can be stably used, when the temperature varies by the operation of the processor unit 501 or the like.

The current mirror circuit 20 includes the PMOS transistor 103 and the PMOS transistor 104. The PMOS transistor 103 is connected between the power supply VDD and the node N1 and has the gate terminal connected to the node N1. The PMOS transistor 104 is connected between the power supply VDD and the node N2 and has the gate terminal connected to the node N1. The NMOS transistor 101 is connected to the node Ni and the power supply GND different from the power supply VDD. The compensation circuit 30 includes the NMOS transistor 105, which is connected between the node N2 and the node N3 and has the gate terminal connected to the node N2, and the NMOS transistor 106, which is connected between the node N3 and GND and has the gate terminal connected to the node N3.

The NMOS transistor 106 performs an operation of receiving the reference voltage Vref through the gate terminal and mutually compensating for the variations on performances of the NMOS transistor 101 serving as the current source of the current mirror circuit 20. The NMOS transistor 105 performs an operation of compensating for the variations on performances of the NMOS transistor 102 or 102a, which generates the step-down potential VDDI or VB. The step-down potential VDDI or VB can reduce the effect of variations on performances due to the manufacturing variation or the temperature dependency, and can obtain a stable voltage and current. The step-down circuit 100 and the constant current circuit 200 can reduce the effect of variations on performances due to the manufacturing variation or the temperature dependency, and can obtain a stable voltage and current. Thus, the step-down potential VDDI and the constant current Is are respectively supplied from the step-down circuit 100 and the constant current circuit 200. When the temperature fluctuates, the DRAM 400 can function normally and can be stably used. Consequently, since the storage unit 502 functions normally, the computer system 500 can function normally, and can be stably used, when the temperature is varied by the operation of the processor unit 501 or the like.

The NMOS transistor 102 or 102a is connected to the source follower circuit.

In the semiconductor circuit, it is possible to reduce a circuit scale as compared with a step-down circuit using an operational amplifier, and a phase compensation capacitor, which increases a layout area, is unnecessary. Thus, the step-down circuit 100 (or the constant current circuit 200) can reduce a chip layout area as compared with the step-down circuit using the operational amplifier. Since the chip size of the DRAM 400 can be reduced, the cost of the computer system 500 can be reduced.

The type of step-down circuit 100 and the type of constant current circuit 200 have been described as embodiments of semiconductor circuits of the present invention, but the present embodiment is not limited thereto. If there are provided the NMOS transistor 101, the NMOS transistor 102 (or 102a) of the source follower configuration, the current mirror circuit 20, and the compensation circuit 30 and the compensation circuit 30 is configured to reduce the effect of variations on performances of the NMOS transistors 101 and 102 (or 102a), any type is possible. In terms of two power supply lines of the power supply VDD and GND and MOS transistors including the PMOS transistor and the NMOS transistor, it is possible to make a connection to other power supply lines and to make a change to other channel types of MOS transistors.

The type in which the computer system 500 of the third embodiment includes the processor unit 501, the storage unit 502, and the interface unit 503 has been described, but the present embodiment is not limited thereto. Also, a type having other functions and a type without an interface unit are possible. The type of DRAM 400 having the step-down circuit 100 and the constant current circuit 200 has been described, but the present embodiment may be provided in a type having one of the step-down circuit 100 and the constant current circuit 200 and may be provided in separate semiconductor devices of the processor unit 501 and the interface unit 503, not the DRAM 400 of the storage unit 502.

In the embodiment, an example of a circuit using MOS transistors has been described, but it is possible to make a change to other transistors if element variations occur in the transistors.

The embodiments of methods, software, firmware or codes described above may be implemented by instructions or codes stored on a machine-accessible or machine readable medium. The instructions or codes are executable by a processing element or processing unit. The machine-accessible/readable medium may include, but is not limited to, any mechanisms that provide, store and/or transmit information in a form readable by a machine, such as a computer or electronic system. In some cases, the machine-accessible/readable medium may include, but is not limited to, random-access memories (RAMs), such as static RAM (SRAM) or dynamic RAM (DRAM), read-only memory (ROM), magnetic or optical storage medium and flash memory devices. In other cases, the machine-accessible/readable medium may include, but is not limited to, any mechanism that receives, copies, stores, transmits, or otherwise manipulates electrical, optical, acoustical or other form of propagated signals such as carrier waves, infrared signals, digital signals, including the embodiments of methods, software, firmware or code set forth above.

The term “configured” is used to describe a component, section or part of a device includes hardware and/or software that is constructed and/or programmed to carry out the desired function.

Furthermore, the particular features, structures, or characteristics may be combined in any suitable manner in one or more embodiments.

The terms of degree such as “substantially,” “about,” and “approximately” as used herein mean a reasonable amount of deviation of the modified term such that the end result is not significantly changed. For example, these terms can be construed as including a deviation of at least ±5 percents of the modified term if this deviation would not negate the meaning of the word it modifies.

It is apparent that the present invention is not limited to the above embodiments, but may be modified and changed without departing from the scope and spirit of the invention.

What is claimed is:

1. A device comprising:
a first transistor controlled by a first control voltage;
a first current mirror circuit driven by the first transistor as a first current source;
a second transistor driven by the first current mirror circuit, the second transistor having a first output voltage that varies depending on the first control voltage; and
a first compensation circuit reducing variations of the first output voltage, the variations of the first output voltage being caused by variations in performance of the first and second transistors.

2. The device according to claim 1, wherein the first transistor is electrically coupled to a first node as an input terminal that controls a first output current from the first current mirror circuit, and the first transistor has a first control terminal that receives the first control voltage,
the second transistor having a second control terminal that is electrically coupled to a second node as an output terminal of the first current mirror circuit, and
the first compensation circuit is electrically coupled to the second node.

3. The device according to claim 2, wherein the first current mirror circuit comprises:
a third transistor electrically coupled between a first power line and the first node, the third transistor having a third control terminal that is electrically coupled to the first node; and
a fourth transistor electrically coupled between the first power line and the second node, the fourth transistor having a fourth control terminal that is electrically coupled to the first node,
wherein the first transistor is electrically coupled between the first node and a second power line which is different in potential from the first power line, and
wherein the first compensation circuit comprises:
a fifth transistor electrically coupled between the second node and a third node, the fifth transistor having a fifth control terminal that is electrically coupled to the second node; and
a sixth transistor electrically coupled between the second power line and the third node, the sixth transistor having a sixth control terminal that is electrically coupled to the third node.

4. The device according to claim 3, wherein the third and fourth transistors are first conductivity type transistors, and the first, second, fifth and sixth transistors are second conductivity type transistors.

5. The device according to claim 4, wherein the fifth transistor is connected in source-follower configuration between the second node and the third node.

6. The device according to claim 3, further comprising:
a second current mirror circuit driven by the second transistor as a second current source, the second current mirror circuit having an input electrically coupled to a fourth node,
wherein the first compensation circuit reduces variations of a second output current from the second current mirror circuit.

7. The device according to claim 6, further comprising:
a first resistance electrically coupled between the second transistor and the second power line,
wherein the second transistor s eclectically coupled between the fourth node and the first resistance.

8. The device according to claim 7, wherein the second current mirror circuit comprises:
a seventh transistor electrically coupled between the first power line and the fourth node, the seventh transistor having a seventh control terminal that is electrically coupled to the fourth node; and
an eighth transistor electrically coupled between the first power line and an output of the second current mirror circuit, the eighth transistor having an eighth control terminal that is electrically coupled to the fourth node.

9. A semiconductor circuit comprising:
a first transistor having a first control terminal that receives a first control voltage, the first transistor being eclectically coupled between a first power line and a first node;
a first current mirror circuit having a first input being electrically coupled to the first node, the first current mirror circuit having a first output being electrically coupled to a second node;
a second transistor having a first control terminal that is electrically coupled to the second node, the second transistor being electrically coupled between a second power line and a third node; and
a first compensation circuit being electrically coupled between the second node and the first power line, the first compensation circuit compensating a first variation in performance of the first transistor, the first compensation circuit compensating a second variation in performance of the second transistor.

10. The semiconductor circuit according to claim 9, wherein the first compensation circuit comprises:
a third transistor compensating the first variation in performance of the first transistor; and
a fourth transistor compensating the second variation in performance of the second transistor.

11. The semiconductor circuit according to claim 10, wherein the third transistor is electrically coupled between the second node and a third node, the third transistor has a third control terminal that is electrically coupled to the second node; and
the fourth transistor is electrically coupled between the second power line and the third node, the fourth transistor has a fourth control terminal that is electrically coupled to the third node.

12. The semiconductor circuit according to claim 11, wherein the first current mirror circuit comprises:
a fifth transistor electrically coupled between the second power line and the first node, the fifth transistor having a third control terminal that is electrically coupled to the first node; and
a sixth transistor electrically coupled between the second power line and the second node, the sixth transistor having a fourth control terminal that is electrically coupled to the first node.

13. A computer system comprising:
a processor; and
a storage unit storing information,
the storage unit comprising:
a peripheral circuit controlling read and write operations to the storage area;
a semiconductor circuit comprising:
a first transistor controlled by a first control voltage;
a first current mirror circuit driven by the first transistor as a first current source;
a second transistor driven by the first current mirror circuit, the second transistor having a first output voltage that varies depending on the first control voltage; and
a first compensation circuit reducing variations of the first output voltage, the variations of the first output voltage being caused by variations in performance of the first and second transistors.

14. The computer system according to claim 13, wherein the first transistor is electrically coupled to a first node as an input terminal that controls a first output current from the first current mirror circuit, and the first transistor has a first control terminal that receives the first control voltage,
the second transistor having a second control terminal that is electrically coupled to a second node as an output terminal of the first current mirror circuit, and
the first compensation circuit is electrically coupled to the second node.

15. The device according to claim 14, wherein the first current mirror circuit comprises:
a third transistor electrically coupled between a first power line and the first node, the third transistor having a third control terminal that is electrically coupled to the first node; and
a fourth transistor electrically coupled between the first power line and the second node, the fourth transistor having a fourth control terminal that is electrically coupled to the first node,
wherein the first transistor is electrically coupled between the first node and a second power line which is different in potential from the first power line, and
wherein the first compensation circuit comprises:
a fifth transistor electrically coupled between the second node and a third node, the fifth transistor having a fifth control terminal that is electrically coupled to the second node; and
a sixth transistor electrically coupled between the second power line and the third node, the sixth transistor having a sixth control terminal that is electrically coupled to the third node.

16. The device according to claim 15, wherein the third and fourth transistors are first conductivity type transistors, and the first, second, fifth and sixth transistors are second conductivity type transistors.

17. The device according to claim 16, wherein the fifth transistor is connected in source-follower configuration between the second node and the third node.

18. The device according to claim 15, further comprising:
a second current mirror circuit driven by the second transistor as a second current source, the second current mirror circuit having an input electrically coupled to a fourth node,
wherein the first compensation circuit reduces variations of a second output current from the second current mirror circuit.

19. The device according to claim 18, further comprising:
a first resistance electrically coupled between the second transistor and the second power line,
wherein the second transistor is eclectically coupled between the fourth node and the first resistance.

20. The device according to claim 19, wherein the second current mirror circuit comprises:
a seventh transistor electrically coupled between the first power line and the fourth node, the seventh transistor having a seventh control terminal that is electrically coupled to the fourth node; and
an eighth transistor electrically coupled between the first power line and an output of the second current mirror circuit, the eighth transistor having an eighth control terminal that is electrically coupled to the fourth node.
